(19) United States
(12) Patent Application Publication
(10) Pub. No.: US 2012/0167005 A1
(43) Pub. Date: Jun. 28, 2012

(54) CREATING AN IMMERSIVE ENVIRONMENT

(75) Inventors: David Matthews, Seattle, WA (US); Jesse Clay Satterfield, Seattle, WA (US); Stephan Hoefnagels, New York, NY (US); Alice Steinglass, Bellevue, WA (US); Samuel Moreau, Bellevue, WA (US); Jensen Harris, Kirkland, WA (US)

(73) Assignee: MICROSOFT CORPORATION, Redmond, WA (US)

(21) Appl. No.: 12/977,235

(22) Filed: Dec. 23, 2010

(51) Int. Cl. G06F 3/048

(52) U.S. Cl. 715/799; 715/781; 715/801

(57) ABSTRACT

The working area of an immersive environment is presented on a display without relying on any system chrome. Two regions are defined within the immersive environment, one of which is a larger primary region and the second of which is a smaller non-primary region. The two regions are presented so that they not overlap with one another. The content of one executing user-interactive application is presented in the primary region and, simultaneously, content of one or more other executing user-interactive applications are presented in the non-primary region. In some implementations the non-primary is docked to one side of the display.

### BACKGROUND

Managing applications and corresponding running items (e.g., open windows) on a computer has become increasingly difficult and burdensome, as computers are more heavily relied upon now than in the past. The availability of computers having increased computer speed and memory, in addition to improved overall computer performance over the last several years has provided users with the capability to efficiently run multiple applications at the same time, which was not practical in the past. Users can run a large variety of applications, and frequently run more than one application at a time.

Conventional operating systems permit users to view and interact with multiple computing applications through windows. Each of these windows generally includes a frame having controls for interacting with the computing application as well as controls for moving, sizing, or otherwise managing the layout of the window. These window frames, however, occupy portions of a display that might otherwise be dedicated to an application's content. Furthermore, managing the layouts of these windows through these controls can be time-consuming, annoying and distracting to users.

### SUMMARY

This document describes techniques and apparatuses for creating an immersive environment. The immersive environment described herein can present multiple applications without dedicating significant amounts of a display to window frames for the applications. These techniques and/or apparatuses enable a user to view and interact with the content of a single application that is presented full screen (i.e., without relying on system chrome) on a display while maintaining much of the power and flexibility that is available when multiple window frames are available.

In one particular implementation, the working area of an immersive environment is presented on a display without any system chrome. Two regions are defined within the immersive environment, one of which is a larger primary region and the second of which is a smaller non-primary region. The two regions are presented so that they not overlap with one another. The content of one executing user-interactive application is presented in the primary region and, simultaneously, content of one or more other executing user-interactive applications are presented in the non-primary region. In some implementations the non-primary is docked to one side of the display.

This summary is provided to introduce simplified concepts for managing an immersive environment that are further described below in the Detailed Description. This summary is not intended to identify essential features of the claimed subject matter, nor is it intended for use in determining the scope of the claimed subject matter. Techniques and/or apparatuses for managing an immersive environment are also referred to herein separately or in conjunction as the “techniques” as permitted by the context.

### BRIEF DESCRIPTION OF THE DRAWINGS

Embodiments for managing an immersive environment are described with reference to the following drawings. The same numbers are used throughout the drawings to reference like features and components:

FIG. 1 illustrates an example system in which techniques for creating an immersive environment can be implemented.

FIG. 2 illustrates an example display having an immersive environment in which the content of three applications is presented.

FIG. 3 illustrates a method for presenting the content of various applications in an immersive environment.

FIG. 4 illustrates an example immersive environment in which the content of three applications is presented.

FIG. 5 illustrates an example immersive environment in which the content of the application presented in the primary region of FIG. 2 is replaced with the content of a different application.

FIG. 6 illustrates an example immersive environment in which the content of the application presented in the primary region of FIG. 2 has been moved to the non-primary region and the content of another application is presented in the primary region.

FIG. 7 illustrates an example device in which techniques for creating an immersive environment can be implemented.

### DETAILED DESCRIPTION

### Overview

Some operating systems permit users to view and interact with a single computing application with little or no window frame, generally by presenting content of an application on all or nearly all of a computer's display. While this technique permits more of an application's content to be viewed, it lacks much of the flexibility permitted by the window-based techniques

This document describes techniques and apparatuses for creating an immersive environment in which a user can view and interact with the content of a single application that is presented full screen (i.e., without system chrome) on a display while maintaining much of the power and flexibility that is available when multiple window frames are available. In particular, the immersive environment can present multiple applications without dedicating significant portions of the display to window frames for the applications.

### Example Environment

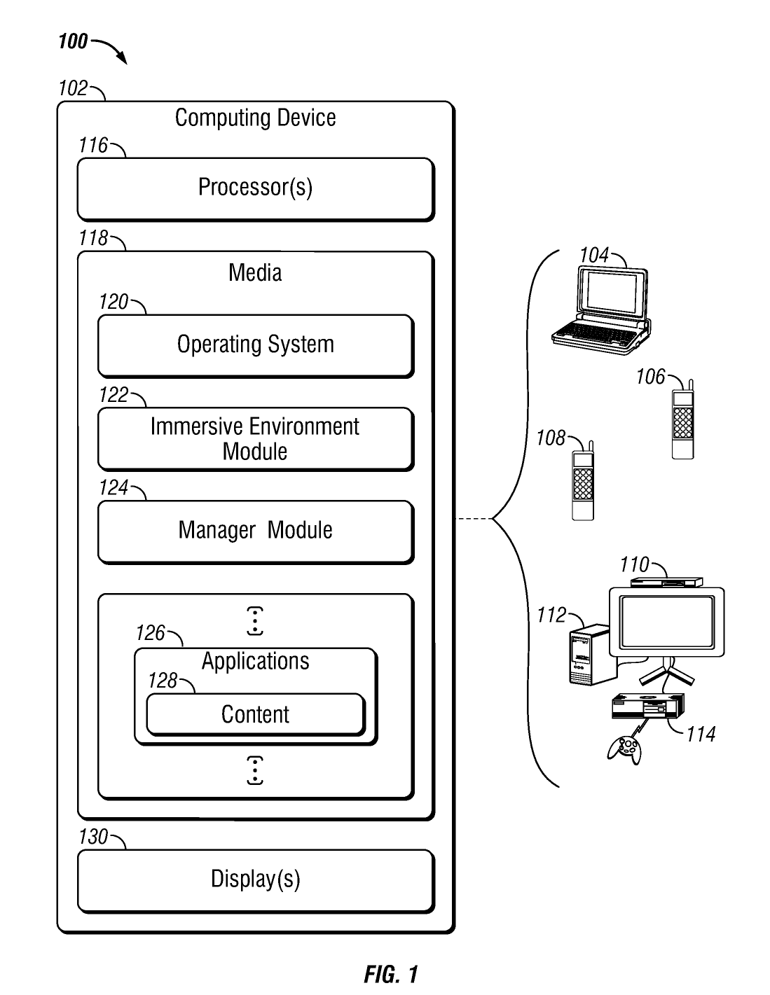

FIG. 1 illustrates an example system 100 in which techniques for managing an immersive environment can be embodied. System 100 includes a computing device 102, which is illustrated with six examples: a laptop computer 104, a tablet computer 106, a smart phone 108, a set-top box 110, a desktop computer 112, and a gaming device 114, though other computing devices and systems, such as servers and netbooks, may also be used.

Computing device 102 includes computer processor(s) 116 and computer-readable storage media 118 (media 118). Media 118 includes an operating system 120, immersive environment module 122, manager module 124, and applications 126, each of which may provide content 128. Computing device 102 also includes or has access to one or more displays 130, four examples of which are illustrated in FIG. 1.

Immersive environment module 122 provides an environment by which a user may view and interact with one or more of applications 126 and corresponding content 128. In some embodiments, this environment presents content of, and enables interaction with, applications with little or no window frame and/or without a need for a user to manually size or position content. This environment can be, but is not required to be, hosted and/or surfaced without use of a windows-based desktop environment. Thus, in some cases immersive environment module 122 presents an immersive environment that is not a window (even one without a substantial frame) and precludes usage of desktop-like displays (e.g., a taskbar). Further still, in some embodiments this immersive environment is similar to an operating system in that it is not closeable or capable of being un-installed. Examples of immersive environments are provided below as part of describing the techniques, though they are not exhaustive or intended to limit the techniques.

Manager module 124 enables a user to manage an immersive environment and applications 126 presented in the environment. Manager 124 and/or module 122 can be separate from each other and/or operating system 120, or may be combined or integrated in some form. Thus, in some cases operating system 120 includes immersive environment module 122 and manager 124.

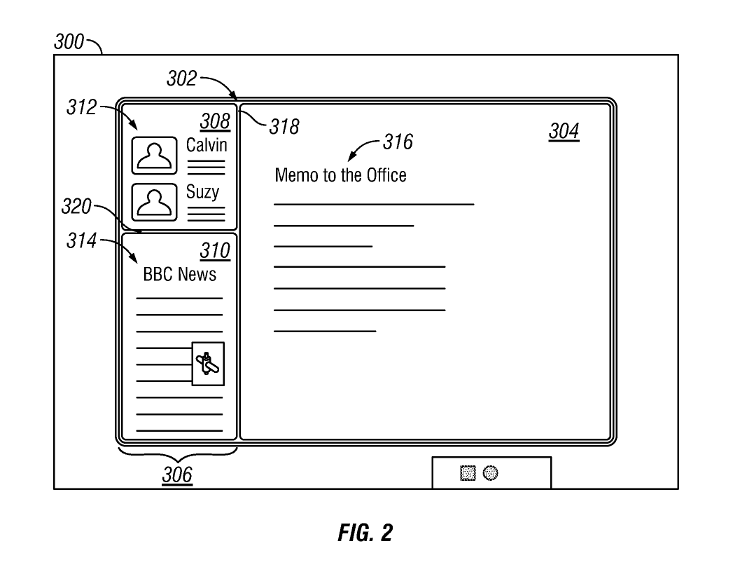

FIG. 2 shows application work area 300 filled with immersive environment 302. The immersive environment 302 is divided by the manager module 124 into two work areas or regions: a primary region 304 and a non-primary region 306. The two regions 304 and 306 are dividing by a splitting boundary 318. Both the primary region 304 and the non-primary region 306 present various content 128 of applications 126. Note that non-primary region 306 includes two non-primary sections 308 and 310, each of which may be used to present content simultaneously (i.e., in parallel) with each other and that of primary region 304. The non-primary sections 308 and 310 are divided by splitting boundary 320. In this example, content from three applications is presented in parallel: content 312 from a social networking website which is presented by a web browser application, content 314 from a news website which is presented by a web browser application, and content 316 from a local document-viewing application.

The applications that present content in the primary region 304 and the non-primary region 306 are not limited to the aforementioned web browser and document-viewing applications. Other illustrative examples of applications that may be presented in the immersive environment 302 include, without limitation, spreadsheet applications, word processing applications, email applications, photo editing applications and the like. Moreover, it should be emphasized that while the content of two applications is shown in the non-primary region 306, the non-primary region 306 more generally may present the content of any number of applications, including the content of only a single application.

In a preferred implementation, the immersive environment 302 in the application work area 300 does not include any system chrome. System chrome refers to the user-interactive graphical elements provided by the system for identifying and managing the regions or windows (e.g., primary and non-primary regions 304 and 306). For example, in the case of Microsoft Windows®, system chrome includes the start button, maximize and minimize buttons, taskbars, title bar labels, and so on. System chrome does not include, however, non-user interactive graphical elements such as visible lines and blank areas that may be provided to visually separate the content of different applications but which do not allow the user to manage the applications.

In some implementations the primary region 304 occupies a substantially larger portion of the work area 300 than the non-primary region 306. This allows the user to interact with applications that present content in the primary region 304 which is currently the principal focus of the user's attention. Content presented by other applications which is of lesser immediate importance or less demanding of the user's attention may then be presented in the smaller non-primary region 306 of the work area 300. In this way the user can focus on his or her most important tasks, while still having immediately access to the content provided by other applications.

The non-primary region 306 may be presented anywhere within the work area 300. Its location may be fixed or variable. For instance, in the case of a variable location, the location of the non-primary region may be user-selectable and/or selected by immersive environment module 124 based, for example, on the capabilities of the display device. On the other hand, if the location of the non-primary region 306 is fixed, it may be docked to one side of the work area 300. Such an arrangement, which is shown in the example of FIG. 2, allows the content in the primary region 304 to be more centrally presented within the work area 304, where it can be most conveniently be viewed by the user.

### Example Methods

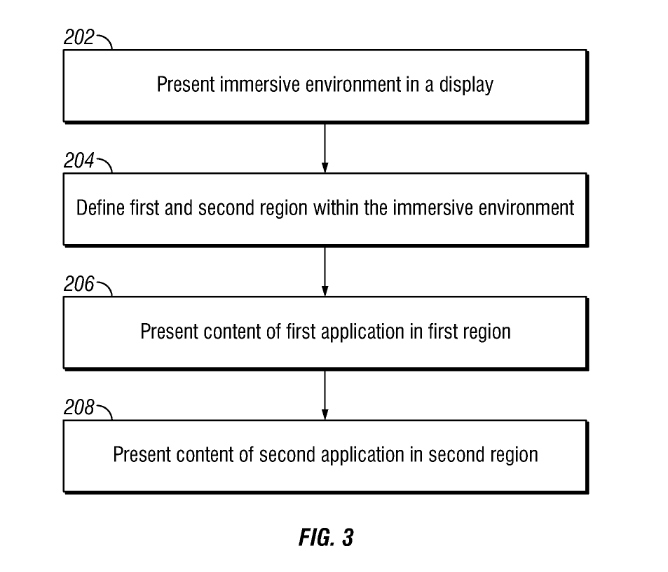

FIG. 3 depicts a method for presenting the content of various applications in an immersive environment. In portions of the following discussion reference may be made to illustrative system 100 of FIG. 1 and illustrative immersive environment 302 of FIG. 2, reference to which is made for example only.

Block 202 presents an immersive environment on a display. The immersive environment does not include system chrome. At block 204 a first region and a second region are defined within the immersive environment. The first and second regions do not overlap with one another and therefore are visible to a user at the same time. The first region may a primary region that is larger in size than the second region. The second region may then serve as a non-primary region that is docked to one side of the display.

At block 206 the content of a first executing user-interactive application is presented in the first region. Likewise, at block 208 the content of one or more other executing user-interactive applications are presented in the second region. The content respectively presented in the first and second regions is presented simultaneously with one another. When two or more applications are presented in the non-primary region, they may be arranged so that that they do not overlap one another.

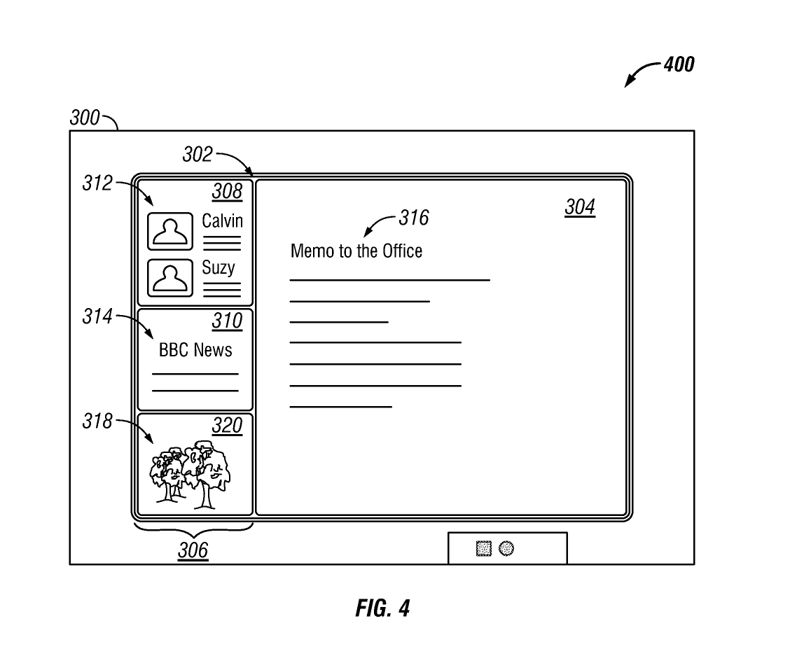

In some cases the non-primary region may be fixed in size. Accordingly, to ensure that content presented by different applications do not overlap, as additional content from additional applications is presented in the non-primary region, the amount of space allocated to each application decreases. For instance, FIG. 4 shows an application work area 400 similar to the application work area shown in FIG. 2, except that in FIG. 4 the content 312, 314 and 318 of three applications is presented in the non-primary region 306 while the content 312 and 314 from only two applications is shown in FIG. 2.

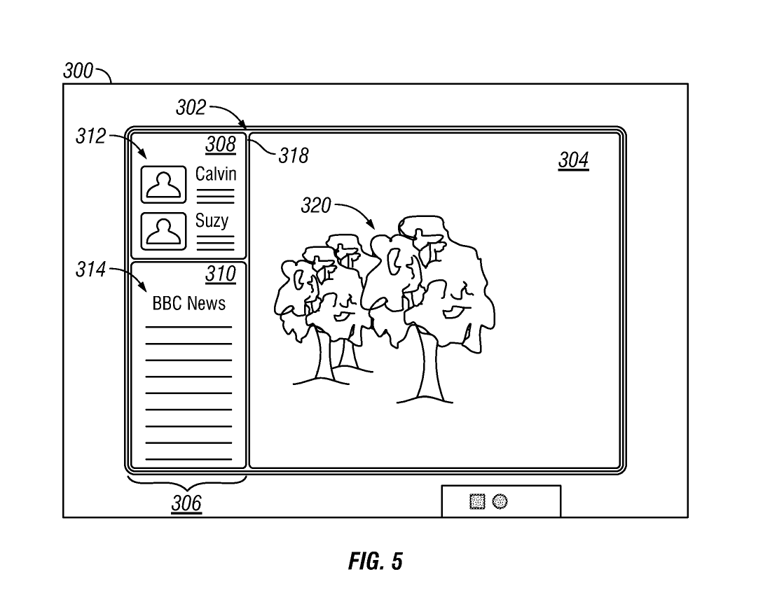

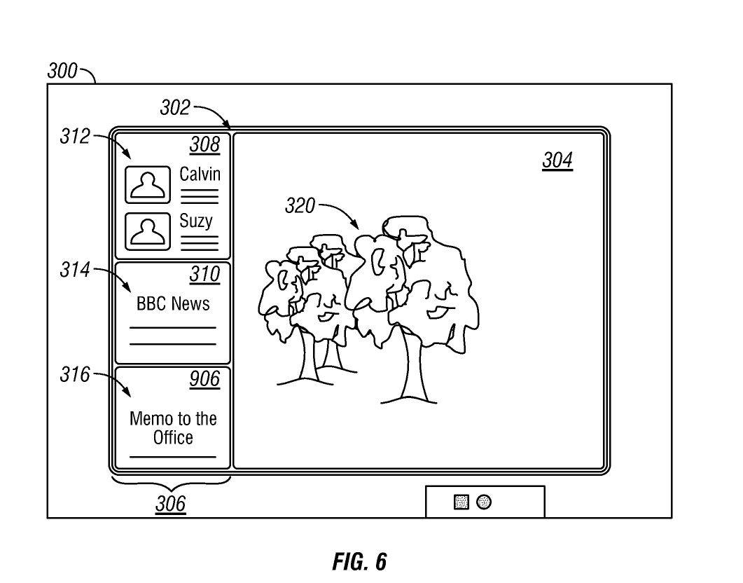

The content displayed in the primary region may be replaced with the content of another application. For instance, if the user opens a new application that is to be presented in the primary region, the content that is currently being presented may be removed from the immersive environment or, alternatively, it may be moved into the non-primary region. FIG. 5 shows an application work area in which the content 316 shown in the primary region of FIG. 2 is replaced with the content of a photo editing application. In this example the original content has been replaced by the content 320 of the photo editing application. However, if the content 312 and 314 of web browser applications shown in FIG. 2 are maintained (“pinned”) in the non-primary region, then, as shown in FIG. 6, the original content 316 of the document-viewing application has been added to the non-primary region 306 without replacing the content 312 and 314 of the social networking website and the news website which are presented by web browser applications.

In general, the content of a given applications may be able to be presented in both the primary region 304 and the non-primary region 306. In some cases, however, an application may be configured so that it can only be presented in one of the regions.

In some implementations the user may be able to remove the non-primary region 306 so that the content in the primary region 304 can occupy the entire work area. At a later time the user can also restore the non-primary region 306. In addition, under certain circumstances the manager 124 may automatically remove the non-primary region. For instance, if the display is rotated into portrait mode the non-primary region may be removed. Likewise, when it is rotated back to landscape mode the manager 124 may restore the non-primary region.

Any of a wide variety of techniques and apparatuses may be provide for allowing users to manage the immersive environment. Such user interface techniques enable a user to select when, where, and/or under what conditions to present applications in this immersive environment. For instance, the manager module 124 of FIG. 1 may enable a user to manage the immersive environment and the applications presented in the environment. In particular, the manager module 124 may enable selection of the user interface with a non-visual selector, such as a hot key or selector movement (e.g., a mouse selector moved to a right edge of primary region 304) or, in the case of a touch screen, a gesture. In some other cases, however, the manager module 124 enables selection through a displayed, selectable control. Illustrative examples of user interface techniques and apparatuses that may be used in connection with an immersive environment may be found in co-pending U.S. Appl. Ser. No. [Docket No. 331053.01].

Regardless of the particular user interface that is employed, the techniques for creating an immersive environment discussed herein allow users to simultaneously manage multiple applications. Assume, for example, that a user wishes to select a music application that he used yesterday while maintaining an immersive presentation of work-related memos that are currently in a primary area of an immersive environment. These techniques can provide a user interface that presents recently-used applications, such as the music application, and enables the user to quickly and easily present the music application in the primary area while automatically moving the work-related memos into the non-primary area of the immersive environment.

Also by way of example, assume that a user wishes to begin his immersive session each day with the same three applications—a sports website, a business-news website, and work-related memos. These techniques permit the user to select these three applications to be automatically presented and maintained in the immersive environment. The user may simply open the immersive environment or logon to his computing device to have these three applications presented in the environment.

The preceding discussion describes methods in which the techniques may operate to provide an immersive environment in the work area of a display. These methods are shown as sets of blocks that specify operations performed but are not necessarily limited to the order shown for performing the operations by the respective blocks.

Aspects of these methods may be implemented in hardware (e.g., fixed logic circuitry), firmware, software, manual processing, or any combination thereof. A software implementation represents program code that performs specified tasks when executed by a computer processor, such as software, applications, routines, programs, objects, components, data structures, procedures, modules, functions, and the like. The program code can be stored in one or more computer-readable memory devices, both local and/or remote to a computer processor. The methods may also be practiced in a distributed computing environment by multiple computing devices.

### Example Device

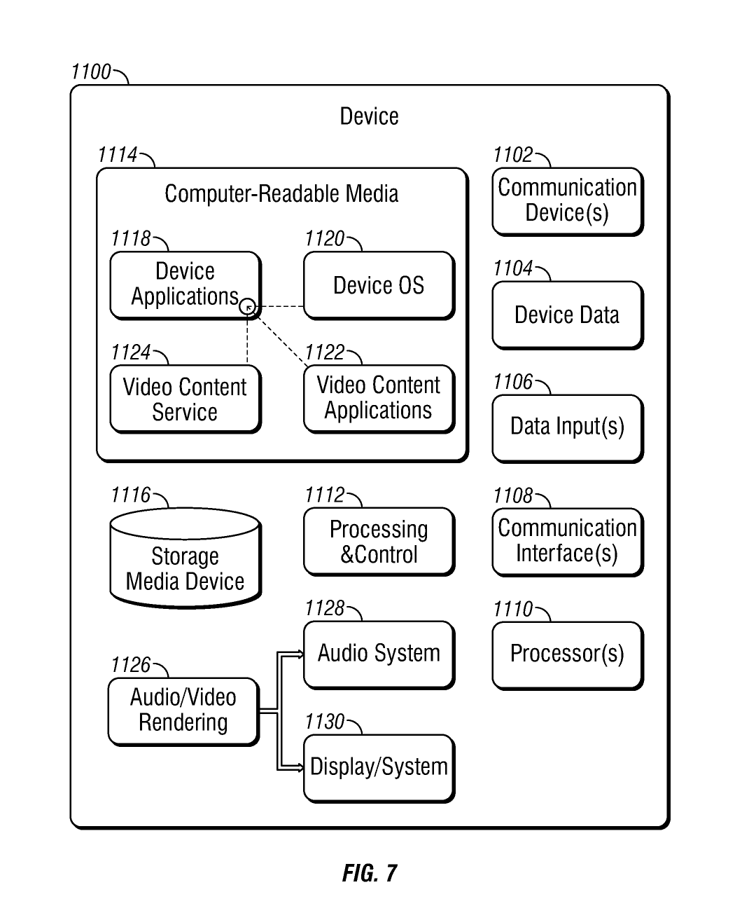

FIG. 7 illustrates various components of an example device 1100 that can be implemented as any type of client, server, and/or computing device as described with reference to the previous FIGS. 1-10 to implement techniques for managing an immersive environment. In embodiments, device 1100 can be implemented as one or a combination of a wired and/or wireless device, as a form of television client device (e.g., television set-top box, digital video recorder (DVR), etc.), consumer device, computer device, server device, portable computer device, user device, communication device, video processing and/or rendering device, appliance device, gaming device, electronic device, and/or as another type of device. Device 1100 may also be associated with a user (e.g., a person) and/or an entity that operates the device such that a device describes logical devices that include users, software, firmware, and/or a combination of devices.

Device 1100 includes communication devices 1102 that enable wired and/or wireless communication of device data 1104 (e.g., received data, data that is being received, data scheduled for broadcast, data packets of the data, etc.). Device data 1104 or other device content can include configuration settings of the device, media content stored on the device, and/or information associated with a user of the device. Media content stored on device 1100 can include any type of audio, video, and/or image data. Device 1100 includes one or more data inputs 1106 via which any type of data, media content, and/or inputs can be received, such as user-selectable inputs, messages, music, television media content, recorded video content, and any other type of audio, video, and/or image data received from any content and/or data source.

Device 1100 also includes communication interfaces 1108, which can be implemented as any one or more of a serial and/or parallel interface, a wireless interface, any type of network interface, a modem, and as any other type of communication interface. Communication interfaces 1108 provide a connection and/or communication links between device 1100 and a communication network by which other electronic, computing, and communication devices communicate data with device 1100.

Device 1100 includes one or more processors 1110 (e.g., any of microprocessors, controllers, and the like), which process various computer-executable instructions to control the operation of device 1100 and to implement embodiments for managing an immersive environment. Alternatively or in addition, device 1100 can be implemented with any one or combination of hardware, firmware, or fixed logic circuitry that is implemented in connection with processing and control circuits that are generally identified at 1112. Although not shown, device 1100 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

Device 1100 also includes computer-readable storage media 1114, such as one or more memory devices that enable persistent and/or non-transitory data storage (in contrast to mere signal transmission), examples of which include random access memory (RAM), non-volatile memory (e.g., any one or more of a read-only memory (ROM), flash memory, EPROM, EEPROM, etc.), and a disk storage device. A disk storage device may be implemented as any type of magnetic or optical storage device, such as a hard disk drive, a recordable and/or rewriteable compact disc (CD), any type of a digital versatile disc (DVD), and the like. Device 1100 can also include a mass storage media device 1116.

Computer-readable storage media 1114 provides data storage mechanisms to store device data 1104, as well as various device applications 1118 and any other types of information and/or data related to operational aspects of device 1100. For example, device operating system 1120 can be maintained as a computer application with computer-readable storage media 1114 and executed on processors 1110. Device applications 1118 may include a device manager, such as any form of a control application, software application, signal-processing and control module, code that is native to a particular device, a hardware abstraction layer for a particular device, and so on.

Device applications 1118 also include any system components or modules to implement techniques for managing an immersive environment. In this example, device applications 1118 can include video content applications 1122, such as when device 1100 is implemented as a client device. Alternatively or in addition, device applications 1118 can include a video content service 1124, such as when device 1100 is implemented as a media content service. Video content applications 1122 and video content service 1124 are shown as software modules and/or computer applications. Alternatively or in addition, video content applications 1122 and/or video content service 1124 can be implemented as hardware, software, firmware, or any combination thereof.

Device 1100 also includes an audio and/or video rendering system 1126 that generates and provides audio data to an audio system 1128 and/or generates and provides display data to a display system 1130. Audio system 1128 and/or display system 1130 can include any devices that process, display, and/or otherwise render audio, display, and image data. Display data and audio signals can be communicated from device 1100 to an audio device and/or to a display device via an RF (radio frequency) link, S-video link, composite video link, component video link, DVI (digital video interface), analog audio connection, or other similar communication link. In an embodiment, audio system 1128 and/or display system 1130 are implemented as external components to device 1100. Alternatively, audio system 1128 and/or display system 1130 are implemented as integrated components of device 1100.

Techniques for providing an immersive environment, of which the above-described methods are examples, may be embodied on one or more of the entities shown in system 100 of FIG. 1 and/or example device 1100 described above, which may be further divided, combined, and so on. Thus, system 100 and/or device 1100 illustrate some of many possible systems or apparatuses capable of employing the described techniques. The entities of system 100 and/or device 1100 generally represent software, firmware, hardware, whole devices or networks, or a combination thereof. In the case of a software implementation, for instance, the entities (e.g., manager 124 of FIG. 1) represent program code that performs specified tasks when executed on a processor (e.g., processor(s) 116 of FIG. 1). The program code can be stored in one or more computer-readable memory devices, such as computer-readable storage media 118 or computer-readable media 1114. The features and techniques described herein are platform-independent, meaning that they may be implemented on a variety of commercial computing platforms having a variety of processors.

### CONCLUSION

Although embodiments of techniques and apparatuses for managing an immersive environment have been described in language specific to features and/or methods, it is to be understood that the subject of the appended claims is not necessarily limited to the specific features or methods described. Rather, the specific features and methods are disclosed as example implementations for managing an immersive environment.

1. A computer-implemented method, comprising:
presenting on a display an immersive environment that does not include system chrome;
defining within the immersive environment presented on the display a first region and a second region that does not overlap with the first region; and
simultaneously presenting content of at least a first executing user-interactive application in the first region and content of at least one executing second user-interactive application in the second region.

2. The computer-implemented method of claim 1 wherein the first region is a primary region and the second region is a non-primary region that is docked to one side of the display.

3. The computer-implemented method of claim 1 wherein the first region is configured to display content of a single executing user application and the second region is configured to display content of one or more executing user-interactive applications.

4. The computer-implemented method of claim 3 further comprising simultaneously presenting content of a plurality of executing user-interactive applications in the second region.

5. The computer-implemented method of claim 1 wherein the second region is fixed in size and further comprising arranging the content of each of the plurality of executing user-interactive applications presented in the second region so that they do not overlap with one another.

6. The computer-implemented method of claim 1 wherein simultaneously presenting content of a plurality of executing user-interactive applications in the second region includes presenting content of two executing user-interactive applications in the second region and further comprising:
in response to a user request, presenting in the second region content of a third executing user-interactive application; and
re-sizing the content of at least one of the two executing user-interactive applications in the second region to accommodate the content of the third executing user-interactive application.

7. The computer-implemented method of claim 1 further comprising:
in response to a user request, presenting content of a third executing user-interactive application in the first region; and
without additional user-input, moving the content of the first executing user-interactive application to the second region.

8. The computer-implemented method of claim 1 wherein the content of the second region is selectively removable from the display and further comprising re-sizing the content presented in first region so that it occupies all of the immersive environment.

9. The computer-implemented method of claim 8 wherein the second region is selectively removable by a user.

10. The computer-implemented method of claim 1 further comprising automatically removing the second region from the display without user intervention upon occurrence of a prescribed event or events.

11. The computer-implemented method of claim 11 wherein the prescribed event includes rotation of the display to portrait mode.

12. A computing device, comprising:
a computer-readable storage medium for storing a plurality of user-interactive applications;
a processor for executing the user-interactive applications;
an immersive environment module configured to provide content associated with applications in an immersive environment on a display; and
a manager module configured to define within the immersive environment presented on the display a first region and a second region that does not overlap with the first region such that content associated with a first executing user-interactive application is presented in the first region while content associated with at least one executing second user-interactive application is presented in the second region.

13. The computing device of claim 12 wherein the first region is configured to display content of a single executing user application and the second region is configured to display content of one or more executing user-interactive applications.

14. The computing device of claim 13 wherein the first region is a primary region and the second region is a non-primary region that is docked to one side of the display.

15. The computing device of claim 12 wherein the manager module is further configured to present content of a third executing user-interactive application in the second region upon user request and re-size the content of at least one of the two executing user-interactive applications in the second region to accommodate the content of the third executing user-interactive application.

16. The computing device of claim 12 wherein the manager module is further configured to present content of a third executing user-interactive application in the first region in response to a user request and, without additional user-input, moving the content of the first executing user-interactive application to the second region.

17. A computer-readable medium, comprising:
causing an immersive environment that does not include system chrome to be presented on a display device, said immersive environment including a first region and a second region that do not overlap with one another on the display device;
causing content of at least a first executing user-interactive application to be presented in the first region and content of an executing second user-interactive application to be presented in the second region;
causing a third executing user-interactive application to be presented in the first region upon user request; and
causing, without additional user-intervention, the first executing user-interactive application to be moved to the second region.

18. The computer-readable medium of claim 17 further comprising causing content of the second user-interactive application to remain in the second region while content of the first user-interactive application is moved to the second region such that the content of the first and second user-interactive applications do not overlap with one another.

19. The computer-readable medium of claim 13 wherein the first region is a primary region and the second region is a non-primary region that is docked to one side of the display.

20. The computer-readable medium of claim 13 wherein the second region is selectively removable by a user and automatically removable without user intervention upon occurrence of a prescribed event or events.
